(19) United States
(12) Patent Application Publication
(10) Pub. No.: US 2009/0185383 A1
(43) Pub. Date: Jul. 23, 2009

(54) LIGHT EMITTING PLATE SYSTEM WITH IMPROVED TRANSPARENCY

(75) Inventors: Thomas Jüstel, Witten (DE); Augustinus Gregorius Henricus Meijers, Breda (NL); Dietrich Bertram, Aachen (DE); Helmut Bechtel, Roetgen (DE); Wolfgang Busselt, Roetgen (DE); Herbert Friedrich Boerner, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,759

(22) PCT Filed: Sep. 20, 2005
(86) PCT No.: PCT/IB05/53081

§ 371 Date: Mar. 22, 2007

(30) Foreign Application Priority Data
Sep. 29, 2004 (EP) 04104772.1

(51) Int. Cl. F21V 3/04

(52) U.S. Cl. 362/311.01

(57) ABSTRACT

The invention relates to a light emitting plate system (1), in which the plate (10) is equipped with at least one particle layer (40), the particle (50) of which have been designed to achieve an improved transparency and light extraction efficiency of the plate (10).

This invention relates to the field of light emitting components, in particular to the field of light emitting plate systems. Light emitting plate systems in the sense of the present invention are usually build up in that way that these plates have a layer- or window-like configuration with a first surface and a second surface. Secondly, these plates have a light source—in most applications a lamp—which is located on the side of the layer and/or window in such a way that light, which is emitted from the light source, enters the plate in an angle which is somewhat perpendicular to the first and second surface. By proper build-up of the plate, the light is then reflected, arcuate or curved to leave the plate on either the first or second surface.

However, it has been a problem in prior art light emitting plate systems that these plates cannot be used for all applications due to their intransparency, which is caused by the need to somehow arcuate the light that is emitted from the light source. However, prior art solutions for plates with an enhanced transparency had the drawback of an insufficient light extraction efficiency.

It is therefore an object to provide a light emitting plate system, which has a suitable light extraction efficiency and transparency.

This object is solved by a light emitting plate system with the features of Claim 1. Accordingly, a light emitting plate system is provided, comprising a plate having a layer and/or window—like configuration with a first surface and a second surface opposing to the first surface, a light source which is located on the side of the plate in such a way that most of the light which is emitted from the light source enters the plate in an angle which is somewhat perpendicular to the first and second surface, characterized in that at least one particle layer is provided at least partly on the first and/or second surface, whereby the features of particles of the particle layer have been matched in such a way that the transparency of the light emitting plate system for light with a wavelength of ≧380 nm to ≦700 nm which enters the first or second surface in an angle of ≧45 to ≦90 thereof is ≧0.5 to ≦0.99.

By doing so, a light emitting plate system that fulfils the criteria for most applications both in light extraction efficiency and transparency can be provided easily and efficiently. It should be noted that it is a prominent feature of the present invention that the plate is transparent in both directions, i.e. from the first to the second surface and also from the second to the first surface.

According to a preferred embodiment of the present invention, the transparency of the light emitting plate system for light with a wavelength of ≧300 nm to ≦1300 nm, preferably of ≧250 nm to ≦1500 nm which enters the first and/or second surface in an angle of ≧45 to ≦90 thereof is ≧0.5 to ≦0.99. By doing so, an even larger spectrum of applications for which the light emitting plate system can be of use, is achievable.

According to a preferred embodiment of the present invention, the transparency of the light emitting plate system for light with a wavelength of ≧380 nm to ≦700 nm, preferably of ≧300 nm to ≦1300 nm and most preferred of ≧250 nm to ≦1500 nm which enters the first and/or second surface in an angle of ≧45 to ≦90 thereof is ≧0.7 to ≦0.98, preferably ≧0.9 to ≦0.97.

According to a preferred embodiment of the present invention, the light extraction efficiency of the light, which is emitted from the light source is ≧30 to ≦100%. The term “light extraction efficiency” in the sense of the present invention is to be understood as the fraction of light, which is emitted by the light source and leaves the light emitting plate system and is not absorbed and/or hindered by total reflection to leave the light emitting plate system. According to a preferred embodiment of the present invention, the light extraction efficiency of the light, which is emitted from the light source is ≧40, preferably ≧50 to ≦100%.

According to a preferred embodiment of the present invention, the diffuse reflection of light with a wavelength of ≧500 nm to ≦600 nm which enters the first and/or second surface in an angle of ≧45 to ≦90 thereof is ≧0% to ≦10%. Such a light emitting plate system has proven itself in practice to be most useful.

There are many ways to select the features of the particles of the at least one particle layer to realize a light emitting plate system of the present invention. However, the inventors have found out that one easy and insofar preferred way is to choose the median particle diameter of the particles within certain borders.

According to a preferred embodiment of the present invention, the particles of the at least one particle layer are embedded in a matrix and the median particle diameter d of the particles of the at least one particle layer is

$$from 50 nm \geq d \leq \vert \frac{550 nm}{{n}_{particle} - {n}_{matrix}} \vert$$

whereby n_{particle} is the refractive index of the particles of the particle layer and nₘₐₜᵣᵢₓ is the refractive index of the matrix surrounding the particles. By doing so, it has been shown that a light emitting plate system with the inventive features as set above can be achieved easily and effectfully. Preferably, the median particle diameter d of the particles of the at least one particle layer is from 100 nm≧d≦1000 nm and more preferably from 150 nm≧d≦400 nm.

It should be noted that according to the preferred embodiment of present invention as described above, n_{particle} may be greater than nₘₐₜᵣᵢₓ and vice versa.

However, according to a preferred embodiment of the present invention, the difference |n_{particle}−nₘₐₜᵣᵢₓ| is ≧0.2 and ≦3, preferably ≧0.3 and ≦2 and most preferred ≧0.5 and ≦1.

Furthermore it is preferred that n_{particle} is ≧1.0 and ≦3.5, preferably ≧1.5 and ≦3.

It is also preferred, that nₘₐₜᵣᵢₓ is ≧1.0 and ≦3.5, preferably ≧1.5 and ≦3.

According to a preferred embodiment of the present invention, the particles of the particle layer are embedded in a matrix.

According to a preferred embodiment of the present invention this matrix material is selected from a group comprising glass, silicone, inorganic materials with an refractive index of ≧1.0 and ≦3.5, inorganic polymers, organic polymers, preferably with an refractive index of ≧1.0 and ≦3.5 or mixtures thereof.

According to a preferred embodiment, the matrix material has an absorption in the wavelength range of ≧380 to ≦700 nm of ≧0 cm⁻¹% and ≦1000 cm⁻¹. By doing so, further losses due to the matrix are limited. Preferably, the absorption in the wavelength range of ≧380 to ≦700 nm of ≧0 cm⁻¹ and S≦100 cm⁻¹, most preferred the absorption in the wavelength range of ≧380 to ≦700 nm of ≧0 cm⁻¹ and ≦1 cm⁻¹

According to a preferred embodiment of the present invention, the matrix comprises a fluid. Preferably the fluid comprises at least one silicone material. Furthermore, it is preferred that the kinematic viscosity of the fluid before curing is ≧300 cSt to ≦500 cSt, more preferably ≧350 to ≦450 cSt. It is also preferred that the refractive index at 590 nm is ≧1.40 to ≦1.74, more preferably ≧1.51 to ≦1.63. The absorption coefficient between 400 and 700 nm is preferably ≧0 to ≦0.1 cm⁻¹.

In case a fluid is used as the or one of the matrix materials, it is preferred that the fluid is cured during the production of the plate. The curing is preferably done at 60° C. for 1 hour. Preferably the Shore hardness of the plate after curing is ≧30 to ≦40, more preferred ≧33 to ≦37. Shore hardness is a measure of the resistance of material to indentation by a spring-loaded indenter. The higher the number, the greater the resistance. The Shore hardness is measured with an apparatus known as a Durometer and consequently is also known as ‘Durometer hardness’.

Furthermore it is preferred that the volume shrinkage after the curing is ≧0 to ≦6%, more preferably ≧0 to ≦4%.

According to a preferred embodiment of the present invention, the thickness T of the particle layer is ≧3d and ≦20 d, d being the median particle diameter of the particles of the at least one particle layer. This has been shown in practice to be the best suitable thickness for the particle layer. Preferably, the thickness T of the particle layer is ≧2d and ≦10 d.

According to a preferred embodiment of the present invention, the packing density of the particles is ≧20 to ≦100%, preferably ≧40 to ≦80%. The term “packing density” is to be understood as the volume of particles compared to the layer volume.

According to a preferred embodiment of the present invention, the thickness T of the particle layer is ≧0.3 μm and ≦3 μm. This has also been shown to be the best absolute thickness of the particle layer. Preferably, the thickness T of the particle layer is ≧0.5 μm and ≦2 μm, most preferred ≧0.8 μm and ≦1.5 μm.

According to a preferred embodiment of the present invention, the scattering power sT, being the product of the scattering parameter s of the particle and the layer thickness T of the at least one particle layer is ≧0 and ≦0.24, preferably ≧0, 1 and ≦0.2. The scattering parameter can be determined for non-absorbing particles from the angle integrated reflection R. For diffuse illumination the scattering parameter of the particles in a layer is given by s=R/(T*(1−R)).

According to a preferred embodiment of the present invention, the plate is made out of a material chosen from a group comprising PMMA, PS, PTFE, PC, glass and mixtures thereof.

It should be noted that in the sense of the present invention, the plate needs not to be a single piece; however, in some applications it is advantageous that the plate consists of two or more sub plates. The term “plate” therefore should not be understood in that way that the plate is always a uniform single piece; also light emitting plate system which employ several plates are addressed by the invention.

According to a preferred embodiment of the present invention, the particles of the at least one particle layers are made out of a material chosen from a group comprising inorganic materials, organic materials and organic polymers, whereby the inorganic materials are preferably selected from a group comprising SiO₂, MgO, Al₂O₃, TiO₂, ZrO₂, sulphides, zeolithes or sodalites. These materials have proven to be most effective.

According to a preferred embodiment of the present invention, the absorption a of the particles of the at least one particle layer for light in the wavelength region from 400 nm to 800 nm is 0≦a≦1 cm⁻¹, more preferred 0.01≦a≦0.5 cm⁻¹ and most preferred 0.02≦a≦0.2 cm⁻¹.

According to a preferred embodiment of the present invention, the thickness of the plate is from ≧0.1 mm to ≦2 cm.

A light emitting plate system according to the present invention is of use in many systems and/or applications, amongst them the following applications:
household applications
room separators in buildings
separation walls in transportation systems
shop applications
windows, especially windows for buildings
car windows
transparent roofs in buildings and vehicles

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims, the figures, the examples and the following description of the respective figure and examples—which in an exemplary fashion—shows several preferred embodiments of a light emitting plate system according to the invention.

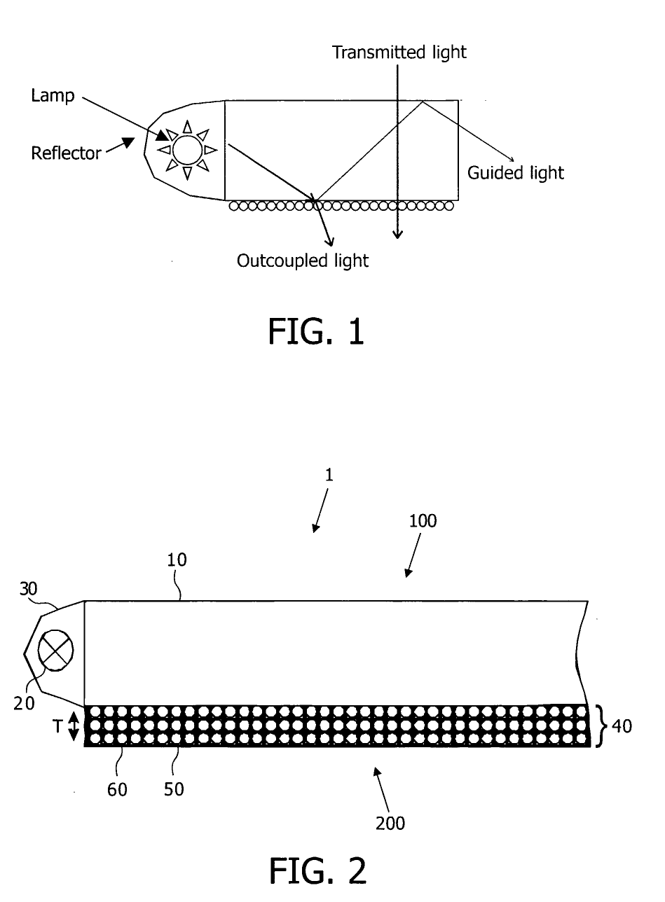

FIG. 1 shows a schematic representation of a transparent light plate

FIG. 2 shows a schematic cross-sectional view of a light emitting plate system according to a first embodiment of the present invention.

FIG. 2 shows a schematic cross-sectional view of a light emitting plate system 1 according to a first embodiment of the present invention. The light emitting plate system 1 comprises a plate 10, which has a layer and/or window-like configuration and has a first surface 100 and a second surface 200 opposing the first surface 100. On a side of the plate 10 perpendicular to the first and second surface 100, 200 a light source 20 is provided. As shown in FIG. 1 this light source is positioned in that way, that most of the light, which is emitted from the light source, enters the plate in an angle, which is somewhat perpendicular to the first and second surface. To achieve this, a reflector 30 is provided around the light source in order to reflect light that is emitted from the light source 20 in directions untowardly the plate 10.

In the present invention, the light source 20 is simply a lamp, however, it should be noted that also guides such as fibers or light guides made out of transparent plastics can be used as light sources within the present invention.

On the second surface 200 of the plate 10, a particle layer 40 with three rows of particles 50 is provided. The particles are embedded in a matrix material 60.

The particles 50 of the particle layer 40 are chosen to have a diameter

which is essentially

$$d = \vert \frac{550 nm}{{n}_{particle} - {n}_{matrix}} \vert$$

whereby n_{particle} is the refractive index of the particles of the particle layer and nₘₐₜᵣᵢₓ is the refractive index of the matrix material. The particles 50 are arranged in the present embodiment as three straight rows, however, it should be noted, that also less ordered particle arrangements may be used within the present invention.

The particle layer 40 has a thickness T of three times the size of the median particle diameter of the particles 50. As set out before, this is advantageous within the present invention.

The light emitting plate system according to the invention is—in a merely exemplarily fashion—furthermore illustrated by the following example:

### EXAMPLE 1

MgO particles (Alfa Aesar, purity 99.95%, n=1.74 and d₅₀%=0.23 μm) have been dispersed in an aqueous medium by milling with YSZ-ZrO₂ pearls (Yttria stabilised zirconia, 1 mm diameter) in polyethylene (PE) wide-neck bottles (1 l) on a slowly rotating roller bench for 12 hours. After sieving of the pearls, the viscosity of the resulting MgO particle suspension is increased to 300 mPa sec. by addition of PVA binder (Hoechst Mowiol 40-88) and wetting agends. The MgO concentration of the suspension was 10 wt. % with a PVA concentration in the liquid phase of 3 wt. %. By doctor blading a uniform particle layer was applied on a 4 mm thick Plexiglass plate (30×40 cm²) with a thickness of 2 μm after drying. The coated plate was inserted into a suitable lamp housing, coupling light into the 30 cm long edge of the plate. In the on-state of the lamp light is emitted homogenously from the Plexiglass plate, while the plate is transparent for visible light in the off-state of the lamp.

1. Light emitting plate system (1) comprising a plate (10) having a layer and/or window—like configuration with a first surface (100) and a second surface (200) opposing to the first surface, a light source (20) which is located on the side of the plate (10) in such a way that most of the light, which is emitted from the light source (20), enters the plate in an angle which is somewhat perpendicular to the first (100) and second surface (200), characterized in that at least one particle layer (40) is provided at least partly on the first and/or second surface, whereby the features of particles (50) of the particle layer (40) have been matched in that way that the transparency of the light emitting plate system for light with a wavelength of ≧380 nm to ≦700 nm which enters the first or second surface in an angle of ≧45 to ≦90 thereof is ≧0.5 to ≦0.99.

2. Light emitting plate system according to claim 1, whereby the diffuse reflection of light with a wavelength of ≧500 nm to ≦600 nm which enters the first and/or second surface in an angle of ≧45 to ≦90 thereof is ≧0% to ≦10%.

3. Light emitting plate system according to claim 1, whereby the particles (50) of the particle layer (40) are embedded in a matrix, the matrix material preferably being selected from a group comprising glass, silicone, inorganic materials with an refractive index of ≧1.0 and ≦3.5, inorganic polymers, organic polymers, preferably with an refractive index of ≧1.0 and ≦3.5 or mixtures thereof.

4. Light emitting plate system according to claim 3, whereby the median particle diameter d of the particles (50) of the at least one particle layer (40) is from ≧50 nm to
$$\leq \vert \frac{550 nm}{{n}_{particle} - {n}_{matrix}} \vert$$
whereby n_{particle} is the refractive index of the particles of the particle layer and nₚₗₐₜₑ is the refractive index of the matrix.

5. Light emitting plate system according to claim 1, whereby the scattering power sT, being the product of the scattering parameter s and the layer thickness T of the particles (50) of the at least one particle layer (40) is ≧0 and ≦0.24.

6. A light emitting plate system according to claim 1, whereby the thickness T of the particle layer (40) is ≧2d and ≦20 d, d being the median particle diameter of the particles (50) of the at least one particle layer (40).

7. A light emitting plate system according to claim 1, whereby the particles of the at least one particle layers are made out of a material chosen from a group comprising inorganic materials, organic materials and organic polymers, whereby the inorganic materials are preferably selected from a group comprising SiO₂, MgO, Al₂O₃, TiO₂, ZrO₂, sulphides, phosphates, borates, zeolithes or sodalites.

8. A light emitting plate system according to claim 1, the absorption a of the particles of the at least one particle layer for light in the wavelength region from 400 nm to 800 nm is 0≦a≦1 cm⁻¹, more preferred 0.01≦a≦0.5 cm⁻¹ and most preferred 0.02≦a≦0.2 cm⁻¹.

9. A light emitting plate system according to claim 1, whereby the plate (10) is made out of a material chosen from a group comprising PMMA, PS, PTFE, PC, glass and mixtures thereof.

10. A system comprising a light emitting plate system according to any of the claim 1, the system being used in one or more of the following applications:
household applications
room separators in buildings
separation walls in transportation systems
shop applications
windows, especially windows for buildings
car windows
transparent roofs in buildings and vehicles
